(19) United States
(12) Patent Application Publication
(10) Pub. No.: US 2023/0283437 A1
(43) Pub. Date: Sep. 7, 2023

(54) METHOD, DEVICE AND COMPUTER READABLE MEDIUM FOR COMMUNICATION

(71) Applicant: NEC CORPORATION, Tokyo (JP)

(72) Inventors: Lin LIANG, Beijing (CN); Gang WANG, Beijing (CN)

(73) Assignee: NEC CORPORATION, Tokyo (JP)

(21) Appl. No.: 18/024,325

(22) PCT Filed: Sep. 18, 2020
(86) PCT No.: PCT/CN2020/116201

§ 371 Date: Mar. 2, 2023

(51) Int. Cl. H04L 5/00

(52) U.S. Cl. CPC H04L 5/0053; H04L 5/0051; H04L 5/0094

(57) ABSTRACT

Embodiments of the present disclosure relate to methods, devices and computer readable media for communication. According to embodiments of the present disclosure, the terminal device performs a cyclic shift on a sequence of uplink control information. The terminal device further performs an orthogonal spread on the sequence with the cyclic shift. The terminal device transmits the processed sequence to the network device. In this way, it avoids wasting transmission resources for DMRS. Further, it also avoids too complicated sequence detections.

### TECHNICAL FIELD

Embodiments of the present disclosure generally relate to the field of telecommunication, and in particular, to methods, devices and computer storage media for transmission of uplink control information.

### BACKGROUND

In order to support transmission of downlink and uplink transport channels, a terminal device needs to transmit UCI to a network device. The transmission of the UCI may be payload-based. The payload-based transmission refers to transmitting signals carrying information bits (also referred to as payload). In the payload-based transmission of UCI, information bits in the UCI will be encoded using channel coding and modulation. Then, the encoded information bits are multiplexed with Demodulation Reference Signals (DMRS) either in a Time Division Multiplexing (TDM) manner or a Frequency Division Multiplexing (FDM) before transmission. At the side of the network device, the network device will first perform a channel estimation using the DMRS, and then coherently combine the encoded information bits using the estimated channel. Thus, the payload-based transmission is also referred to as DMRS based coherent transmission. However, the channel estimation, demodulation and decoding will cause a high latency of the transmission of UCI.

### SUMMARY

In general, embodiments of the present disclosure provide methods, devices and computer storage media for transmission of uplink control information.

In a first aspect, there is provided a method of communication. The method comprises: receiving, at a terminal device and from a network device, an indication for a transmission of uplink control information; processing, based on the indication, a sequence indicating the uplink control information with a cyclic shift; and transmitting, to the network device, the sequence modulated with an orthogonal spread sequence.

In a second aspect, there is provided a method of communication. The method comprises: receiving, at a terminal device and from a network device, an indication for a transmission of uplink control information; encoding a sequence indicating the uplink control information with a basis sequence which excludes at least one subset of basis sequence comprising consecutive same value of bits only; and transmitting the encoded sequence to the network device.

In a third aspect, there is provided a method of communication. The method comprises: receiving, at a terminal device and from a network device, an indication for a transmission of uplink control information; determining the number of bits in the uplink control information based on the a set of uplink resources for transmitting the uplink control channel; and in accordance with a determination that the number of bits in the uplink control information is below a threshold number, transmitting, to the network device, a reduced number of demodulation reference signals and the uplink control information on the set of uplink resources.

In a fourth aspect, there is provided a method of communication. The method comprises: transmitting, at a network device and to a terminal device, an indication for a transmission of uplink control information; and receiving, from the terminal device, a sequence indicating the uplink control information, the sequence being processed with a cyclic shift and modulated with a orthogonal spread sequence.

In a fifth aspect, there is provided a method of communication. The method comprises: transmitting, at a network device and to a terminal device, an indication for a transmission of uplink control information; and receiving a sequence encoded with a basis sequence which excludes at least one subset of basis sequence comprising consecutive same value of bits only.

In a sixth aspect, there is provided a method of communication. The method comprises: transmitting, at a terminal device and to a network device, an indication for a transmission of uplink control information; and in accordance with a determination that the number of bits in the uplink control information is below a threshold number, receiving, from the terminal device, a reduced number of demodulation reference signals and the uplink control information on the set of uplink resource.

In a seventh aspect, there is provided a terminal device. The terminal device comprises a processor and a memory coupled to the processor. The memory stores instructions that when executed by the processor, cause the terminal device to perform the method according to any one of the first, second or third aspect of the present disclosure.

In an eighth aspect, there is provided a network device. The network device comprises a processor and a memory coupled to the processor. The memory stores instructions that when executed by the processor, cause the network device to perform the method according to any one of the fourth, fifth or sixth aspect of the present disclosure.

In a ninth aspect, there is provided a computer readable medium having instructions stored thereon. The instructions, when executed on at least one processor, cause the at least one processor to perform the method according to any one of the first, second or third aspect of the present disclosure.

In a tenth aspect, there is provided a computer readable medium having instructions stored thereon. The instructions, when executed on at least one processor, cause the at least one processor to perform the method according to any one of the fourth, fifth or sixth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a schematic diagram illustrating a process for transmission of uplink control information according to embodiments of the present disclosure;

FIG. 3 illustrates a schematic diagram illustrating a process for transmission of uplink control information according to embodiments of the present disclosure;

FIG. 4 illustrates a schematic diagram illustrating a process for transmission of uplink control information according to embodiments of the present disclosure;

FIG. 5 illustrates an example method of communication implemented at a terminal device in accordance with some embodiments of the present disclosure;

FIG. 6 illustrates an example method of communication implemented at a terminal device in accordance with some embodiments of the present disclosure;

FIG. 7 illustrates an example method of communication implemented at a terminal device in accordance with some embodiments of the present disclosure;

FIG. 8 illustrates an example method of communication implemented at a network device in accordance with some embodiments of the present disclosure;

FIG. 9 illustrates an example method of communication implemented at a network device in accordance with some embodiments of the present disclosure;

FIG. 10 illustrates an example method of communication implemented at a network device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As described above, in the payload-based transmission, the channel estimation, demodulation and decoding will cause a high latency of the transmission of UCI. According to some conventional technologies, a solution for demodulation reference signal (DMRS)-less physical uplink control channel (PUCCH) has been proposed, which means UCI can be transmitted without DMRS. For example, sequence based PUCCH transmission has been proposed. In order to enhance PUCCH coverage, in some embodiments, the physical uplink shared channel (PUSCH)-repetition-type B like PUCCH repetition for UCI may comprises bits which are less than 11. The network device may transmit dynamic PUCCH repetition factor indication to the terminal device. The indication may be explicit or implicit. In other embodiments, DMRS bundling cross PUCCH repetitions has also been proposed. The network device may obtain properties of channels between the terminal device and the network device. For example, since the DMRS is known, the network device may compare the received DMRS with the original DMRS to obtain the channel properties. If the signal-to-noise ratio (SNR) of the channel is high, the number of DMRSs may be less. If the SNR of the channel is low, the network device may need more DMRSs to obtain the channel properties.

According to conventional technologies, there may be two approaches to transmit UCI in a PUCCH channel, for example, DMRS-based coherent transmission and DMRS-less noncoherent transmission. In the situation of the DMRS-based coherent transmission, the terminal device may encode the UCI using channel coding and modulation. The terminal device may further multiplex the UCI with DMRS. The network device may perform a channel estimation using the DMRS and coherently combine the encoded UCI using the channel estimation.

For DMRS-less noncoherent transmission, the terminal device may transmit the UCI with a sequence without inserting DMRS in the transmission. The network device may perform a sequence detection and determine the UCI based on the detected sequence.

In New Radio (NR) Release-15 (Rel-15), both noncoherent and coherent PUCCHs are used. Specifically, PUCCH format 0 may be with DMRS-less noncoherent transmission and PUCCH format 1/2/3/4 may be with DMRS-based coherent transmission. For example, the physical uplink control channel supports multiple formats as shown in Table 1 below. In case intra-slot frequency hopping is configured for PUCCH formats 1, 3, or 4 according to clause 9.2.1 of TS38.213, the number of symbols in the first hop is given by └N_{symb}^{PUCCH}/2┘ where N_{symb}^{PUCCH} is the length of the PUCCH transmission in an Orthogonal Frequency Division Multiplexing (OFDM) symbols.

TABLE 1

| PUCCH | Length in OFDM | Number of |
|---|---|---|
| format | symbols N_{symb}^{PUCCH} | bits |
| 0 | 1-2 | ≤2 |
| 1 | 4-14 | ≤2 |
| 2 | 1-2 | >2 |
| 3 | 4-14 | >2 |
| 4 | 4-14 | >2 |

In high SNR region, coherent transmission is better than noncoherent transmission. However, in low SNR region, non-coherent transmission should have better link level performance than coherent transmission. The channel estimation quality at low SNR is very poor, which may lead to significant performance degradation in demodulation and decoding. The energy spent on the DMRS does not contain useful information. Hence, one may improve the channel estimation quality by using more DMRS symbols/REs, but increasing number of DMRS symbols reduces the energy available for the information transmission. Since the coverage enhancement is targeting cell edge UEs that operate at low SNR, DMRS-less non-coherent PUCCH transmission should a good candidate scheme to improve PUCCH coverage.

According to embodiments of the present disclosure, the terminal device performs a cyclic shift on a sequence of uplink control information. The terminal device further performs an orthogonal spread on the sequence with the cyclic shift. The terminal device transmits the processed sequence to the network device. In this way, it avoids wasting transmission resources for DMRS. Further, it also avoids too complicated sequence detections.

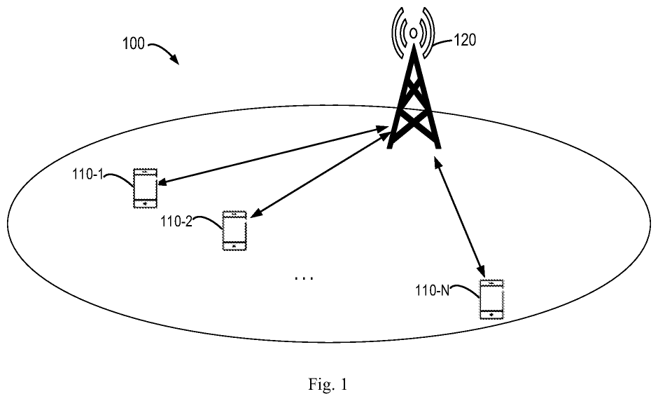

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network terminal device 120. In some embodiments, the network device may be gNB. Alternatively, the network device may be IAB. In the communication system 100, the network devices 120 and the terminal devices 110 can communicate data and control information to each other. The numbers of terminal devices and network devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

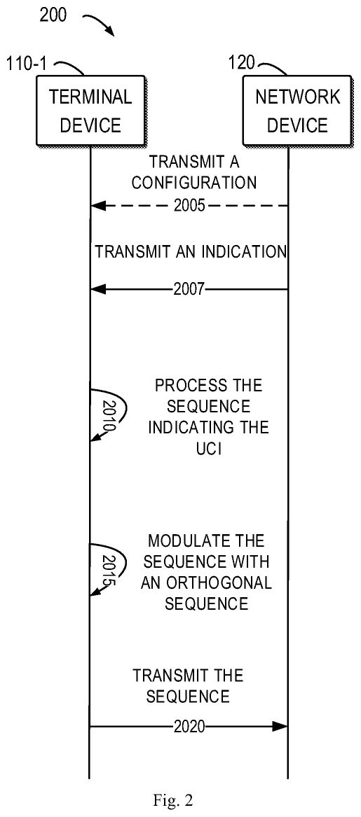

Embodiments of the present disclosure will be described in detail below. Reference is first made to FIG. 2, which shows a signaling chart illustrating process 200 among network devices according to some example embodiments of the present disclosure. Only for the purpose of discussion, the process 200 will be described with reference to FIG. 1. The process 200 may involve the terminal device 110-1 and the network device 120 in FIG. 1.

In some embodiments, the network device 120 may transmit 2005 a configuration for processing UCI to the terminal device 110-1. The configuration may be transmitted via a higher layer. For example, the configuration may be transmitted in radio resource control signaling. Alternatively, the configuration may be transmitted in downlink control information. In other embodiments, the configuration may be preconfigured at the terminal device 110-1. The configuration may indicate a PUCCH format mode. For example, the configuration may comprise a parameter PUCCHformat1CovEnh. Only for the purpose of illustrations, the PUCCH format mode may be PUCCH format 1A. It should be noted that the PUCCH format mode may be any suitable mode. In some embodiments, the configuration may also indicate resources allocated to the terminal device 110-1 for UCI.

The network device 120 transmits 2007 an indication for a transmission of the uplink control information. For example, the indication may be transmitted via downlink control information (DCI). Alternatively, the indication may be transmitted via RRC signaling. In some embodiments, the terminal device 110-1 may generate a value corresponding to information bits in UCI. In some embodiments, the value is a binary value. In other embodiments, the value may be any appropriate value. In some embodiments, the terminal device 110-1 may generate a sequence indicating the UCI based on the value.

The terminal device 110-1 processes 2010 the sequence indicating the UCI with a cyclic shift based on the configuration. In some embodiments, the terminal device 110-1 may determine a sequence cyclic shift based on the uplink control information and the configuration. In this way, the sequence cyclic shift may carry the uplink control information. The terminal device 110-1 may determine the cyclic shift based on the sequence cyclic shift and an initial cyclic shift in the configuration.

In some embodiments, the cyclic shift may be determined based on:

$${α}_{i} = \frac{2 π}{{N}_{sc}^{RB}} ( ( {m}_{0} + {m}_{cs} + {n}_{cs} ( {n}_{s , f}^{μ} , l + {l}^{′} ) ) mod {N}_{sc}^{RB} ) \qquad ( 1 )$$

wherein the α represents the cyclic shift, n_{s,f}^{μ} represents a slot number in a radio frame, l represents a symbol (for example, an Orthogonal Frequency Division Multiplexing, OFDM, symbol) number in the uplink control information, l′ is an index of a symbol in a slot that corresponds to the first symbol of the uplink control information in the slot, m₀ represents the initial cyclic shift, m_{cs} represents the sequence cyclic shift, and N_{sc}^{RB} represents the number of subcarriers in a resource block. It should be noted that the cyclic shift may be determined through any suitable manners. In some embodiments, the initial cyclic shift m₀ may be given by the third generation partnership project (3GPP) standard (for example, TS 38.213) for PUCCH format 0 and 1 while for PUCCH format 3 and 4 is defined in subclause 6.4.1.3.3.1 in the 3GPP standard (for example, TS 38.213). The sequence cyclic shift m_{cs} may be determined based on the uplink control information. For example, the sequence cyclic shift m_{cs} may be determined based on the uplink control information according to subclause 9.2 of TS 38.213. For example, m_{cs} may be determined from value of one hybrid automatic repeat request (HARM)-acknowledgement (ACK) information bit or from the values of two HARQ-ACK information bits as in Table 2 and Table 3 below.

TABLE 2
Mapping of values for one HARQ-ACK information
bit to sequences for PUCCH format

| HARQ-ACK Value | 0 | 1 |
|---|---|---|
| Sequence cyclic shift | m_{cs} = 0 | m_{cs} = 6 |

TABLE 3
Mapping of values for two HARQ-ACK information
bits to sequences for PUCCH format

| HARQ-ACK Value | {0, 0} | {0, 1} | {1, 1} | {1, 0} |
|---|---|---|---|---|
| Sequence cyclic shift | m_{cs} = 0 | m_{cs} = 3 | m_{cs} = 6 | m_{cs} = 9 |

It should be noted that values in Tables 2 and 3 are only examples not limitations.

In some embodiments, the parameter “n_{cs}” may be determined based on:

n_{cs}(n_{s,f}^{μ},l)=Σₘ₌₀7^{m}c(14·8n_{s,f}^{μ}+8l+m) (2)

where c(i) represents the pseudo-random which may be defined by subclause 5.2.1 of TS 138.211. The pseudo-random sequence generator shall be initialized with Cᵢₙᵢₜ=n_{ID}, where n_{ID} is given by the higher-layer parameter hoppingId. For example, the pseudo-random c(i) may be determined based on

c(n)=(xₙ(n+N_{C})+x₂(n+N_{C}))mod 2

x₁(n+31)=(x₁(n+3)+x₁(n))mod 2

x₂(n+31)=(x₂(n+3)+x₂(n+2)+x₂(n+1)+x₂(n))mod 2 (3)

where N_{C}=1600 and the first m-sequence x₁(n) shall be initialized with x₁(0)=1, x₁(n)=0, n=1, 2, . . . , 30. The initialization of the second m-sequence, x₂(n), is denoted by cᵢₙᵢₜ=Σᵢ₌₀³⁰x₂(i)·2ⁱ with the value depending on the application of the sequence. In this example, the length M_{PN} is equal to 31. In some embodiments, the pseudo-random sequence may be a short sequence per OFDM symbol.

In some embodiments, the processed sequence may be low peak-to-average-power ratio (Low-PAPR) sequence. For example, the processed sequence may be generated according to:

r_{u,v}^{(α,δ)}(n)=e^{j+n}r̅_{u,v}(n), (4)

wherein the r_{u,v}^{(α,δ})(n) represents the processed sequence, a represents the cyclic shift, r̅_{u,v}(n) represents groups of basic sequences, u represents a group number of a group of base sequences, v represents a base sequence number within the group of base sequences, n represents the n^{th} subcarriers in the resource block, and the value of is δ indicated in the configuration. It should be noted that the processed sequence may be any suitable type of sequences. The value of n may be from 0 to M_{ZC} which in the length of the sequence.

The terminal device 110-1 modulates 2015 the sequence with an orthogonal spread sequence based on the configuration. For example, the sequence may be spread with the orthogonal sequence. In some embodiments, the block of complex-valued symbols r_{u,v}^{(α,δ)}(n) shall be block-wise spread with the orthogonal sequence wᵢ(m) according to:

$$z ( {m}^{′} {N}_{sc}^{RB} {N}_{SF , 0}^{PUCCH , 1 A} + {mN}_{sc}^{RB} + n ) = {w}_{i} ( m ) \cdot {r}_{u , v}^{( α , δ )} ( n ) \qquad ( 5 )$$

$$n = 0 , 1 , … , {N}_{sc}^{RB} - 1$$

$$n = 0 , 1 , … , {N}_{SF , 0}^{PUCCH , 1 A} - 1$$

$${m}^{′} = \{ \begin{matrix}0 & no intra - slot frequency hopping \\ 0 , 1 & intra - slot frequency hopping enabled\end{matrix}$$

where N_{SF,0}^{PUCCH,1A} represents length of PUCCH transmission in a subframe, N_{SF,0}^{PUCCH,1A}=N_{symbol}^{PUCCH,1A} if no intra-slot frequency hopping and N_{SF,0}^{PUCCH,1A}=└N_{symbol}^{PUCCH,1A}/2┘, N_{SF,1}^{PUCCH,1A}=N_{symbol}^{PUCCH,1A}−└N_{symbol}^{PUCCH,1A}/2┘ if intra-slot frequency hopping enabled, m_{cs} represents the sequence cyclic shift, and r_{u,v}^{(α,δ)}(n) represents the processed sequence.

In some embodiments, the orthogonal spread sequence may be determined based on:

$${w}_{i} ( m ) = {e}^{j 2 π \cdot i \cdot m / {N}_{SF , {m}^{′}}^{PUCCH , 1 A}} \qquad ( 6 )$$

where i represents an index of the orthogonal sequence to use, m represents the m^{th} symbol in the orthogonal sequence, and N_{SF,m′}^{PUCCH,1A} represents length of physical uplink control channel (PUCCH) transmission in a slot.

In some embodiments, N_{SF,m′}^{PUCCH,1A}≤7, the orthogonal spread sequence may be given by Table 4 and Table 5. It should be noted that the numbers shown in Tables 4 and 5 are only examples not limitations.

TABLE 4
Number of PUCCH symbols and the
corresponding N_{SF, m′}^{PUCCH, 1A}

| | N_{SF, m′}^{PUCCH, 1A} | |
|---|---|---|
| | No Intra-slot | Intra-slot |
| PUCCH | hopping | hopping |

| N_{symbol}^{PUCCH, 1A} | m′ = 0 | m′ = 0 | m′ = 1 |
|---|---|---|---|
| 4 | 2 | 1 | 1 |
| 5 | 2 | 1 | 1 |
| 6 | 3 | 1 | 2 |
| 7 | 3 | 1 | 2 |
| 8 | 4 | 2 | 2 |
| 9 | 4 | 2 | 2 |
| 10 | 5 | 2 | 3 |
| 11 | 5 | 2 | 3 |
| 12 | 6 | 3 | 3 |
| 13 | 6 | 3 | 3 |
| 14 | 7 | 3 | 4 |

TABLE 5
$Orthogonal sequences {w}_{i} ( m ) = {e}^{j 2 π ϕ ( m ) / {N}_{SF , {m}^{′}}^{PUCCH , 1}} for PUCCH format$

| | φ | | | | | | |
|---|---|---|---|---|---|---|---|
| N_{SF,m′}^{PUCCH,1A} | i = 0 | i = 1 | i = 2 | i = 3 | i = 4 | i = 5 | i = 6 |
| 1 | [0] | — | — | — | — | — | — |
| 2 | [0 0] | [0 1] | — | — | — | — | — |
| 3 | [0 0 0] | [0 1 2] | [0 2 1] | — | — | — | — |
| 4 | [0 0 0 0] | [0 2 0 2] | [0 0 2 2] | [0 2 2 0] | — | — | — |
| 5 | [0 0 0 0 0] | [0 1 2 3 4] | [0 2 4 1 3] | [0 3 1 4 2] | [0 4 3 2 1] | — | — |
| 6 | [0 0 0 0 0 0] | [0 1 2 3 4 5] | [0 2 4 0 2 4] | [0 3 0 3 0 3] | [0 4 2 0 4 2] | [0 5 4 3 2 1] | — |
| 7 | [0 0 0 0 0 0 0] | [0 1 2 3 4 5 6] | [0 2 4 6 1 3 5] | [0 3 6 2 5 1 4] | [0 4 1 5 2 6 3] | [0 5 3 1 6 4 2] | [0 6 5 4 3 2 1] |

For N_{SF,m′}^{PUCCH,1A}>7, in some embodiments, the orthogonal spread sequence may be determined based on:

$${w}_{i} ( m ) = {e}^{j 2 π \cdot φ ( m ) / {N}_{SF , {m}^{′}}^{PUCCH , 1 A}} \qquad ( 7 )$$

In some embodiments, φ(m) is given by Table 6. In Table 6, φ(m)=(i·m)mod N_{SF,m′}^{PUCCH,1A} for N_{SF,m′}^{PUCCH,1A}>8 and is omitted.

TABLE 6

| N_{SF, m′}^{PUCCH, 1A} | i = 0 | i = 1 | i = 2 | i = 3 | i = 4 | i = 5 | i = 6 | i = 7 |
|---|---|---|---|---|---|---|---|---|
| 8 | [0 0 0 0 | [0 4 0 4 | [0 0 4 4 | [0 4 4 0 | [0 0 0 0 | [0 4 0 4 | [0 0 4 4 | [0 4 4 0 |
| | 0 0 0 0] | 0 4 0 4] | 0 0 4 4] | 0 4 4 0] | 4 4 4 4] | 0 2 4 0] | 4 4 0 0] | 4 0 0 4] |

It should be noted that the numbers shown in Table 6 are only examples not limitations.

The terminal device 110-1 transmits 2020 the sequence to the network device 120. For example, the sequence may be transmitted on the resources indicated in the configuration. In this way, transmission resources can be saved. Further, it reduces the burden of maximum likelihood detection.

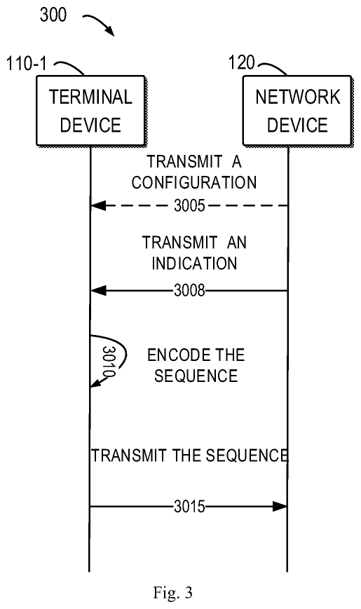

FIG. 3 shows a signaling chart illustrating process 300 among network devices according to some example embodiments of the present disclosure. Only for the purpose of discussion, the process 300 will be described with reference to FIG. 1. The process 300 may involve the terminal device 110-1 and the network device 120 in FIG. 1.

In some embodiments, the network device 120 may transmit 3005 a configuration to the terminal device 110-1. In other embodiments, the configuration may be preconfigured at the terminal device 110-1. The configuration may indicate that on demodulation reference signal (DMRS) is transmitted. In some embodiments, the configuration may indicate that DMRS-less mode is used per enhanced PUCCH format. For example, the configuration may comprise a parameter DMRSlessEncoding. The configuration may be transmitted via higher layers.

The network device 120 may transmit 3008 an indication for a transmission of the uplink control information. For example, the indication may be transmitted via downlink control information (DCI). Alternatively, the indication may be transmitted via RRC signaling.

The terminal device 110-1 may encode 3010 the sequence with a basis sequence. The basis sequence may exclude at least one subset of basis sequence comprising consecutive same value of bits only. For example, the basis sequence may exclude a bit indicating inverting the uplink control information. The terminal device 110-1 may transmit 3015 the sequence to the network device 120. In this way, the complex of the modulated sequence is reduced. Since there is no DMRS used and the channel properties cannot be obtained, the first column in the basis sequence indicating whether the uplink control information is inverted may not be useful any more. For example, the first column in the basis sequence can indicate whether the uplink control information is inverted before transmission but the network device 120 cannot determine whether the uplink control information is inverted through the channel without the DRMS. Therefore, the bit indicating inverting the uplink control information can be omitted.

In some embodiments, for 3≤K≤11, the code block is encoded by:

$${d}_{i} = ( {\sum }_{k = 0}^{K - 1} {c}_{k} \cdot {M}_{i , k} ) mod2 \qquad ( 8 )$$

where i=0, 1, . . . , N−1, N=32, and M_{i,k} represents the basis sequences as defined in Table 7 below, if high layer parameter DMRSlessEncoding is not configured or I_{seq}=0.

In other embodiments, for 3≤K≤10, the code block is encoded by:

$${d}_{i} = ( {\sum }_{k = 0}^{K - 1} {c}_{k} \cdot {M}_{i , k + 1} ) mod 2 \qquad ( 9 )$$

where i=0, 1, . . . , N−1, N=32, and M_{i,k+1} represents the basis sequences as defined in Table 7, if I_{seq}=1. As mentioned above, the first column in the basis sequence indicating whether the uplink control information is inverted may not be useful, thus, M_{i,k+1} is used in this situation.

TABLE 7
Basis sequences for (32, K) code

| i | M_{i, 0} | M_{i, 1} | M_{i, 2} | M_{i, 3} | M_{i, 4} | M_{i, 5} | M_{i, 6} | M_{i, 7} | M_{i, 8} | M_{i, 9} | M_{i, 10} |
|---|---|---|---|---|---|---|---|---|---|---|---|
| 0 | 1 | 1 | 0 | 0 | 0 | 0 | 0 | 0 | 0 | 0 | 1 |
| 1 | 1 | 1 | 1 | 0 | 0 | 0 | 0 | 0 | 0 | 1 | 1 |
| 2 | 1 | 0 | 0 | 1 | 0 | 0 | 1 | 0 | 1 | 1 | 1 |
| 3 | 1 | 0 | 1 | 1 | 0 | 0 | 0 | 0 | 1 | 0 | 1 |
| 4 | 1 | 1 | 1 | 1 | 0 | 0 | 0 | 1 | 0 | 0 | 1 |
| 5 | 1 | 1 | 0 | 0 | 1 | 0 | 1 | 1 | 1 | 0 | 1 |
| 6 | 1 | 0 | 1 | 0 | 1 | 0 | 1 | 0 | 1 | 1 | 1 |
| 7 | 1 | 0 | 0 | 1 | 1 | 0 | 0 | 1 | 1 | 0 | 1 |
| 8 | 1 | 1 | 0 | 1 | 1 | 0 | 0 | 1 | 0 | 1 | 1 |
| 9 | 1 | 0 | 1 | 1 | 1 | 0 | 1 | 0 | 0 | 1 | 1 |
| 10 | 1 | 0 | 1 | 0 | 0 | 1 | 1 | 1 | 0 | 1 | 1 |
| 11 | 1 | 1 | 1 | 0 | 0 | 1 | 1 | 0 | 1 | 0 | 1 |
| 12 | 1 | 0 | 0 | 1 | 0 | 1 | 0 | 1 | 1 | 1 | 1 |
| 13 | 1 | 1 | 0 | 1 | 0 | 1 | 0 | 1 | 0 | 1 | 1 |
| 14 | 1 | 0 | 0 | 0 | 1 | 1 | 0 | 1 | 0 | 0 | 1 |
| 15 | 1 | 1 | 0 | 0 | 1 | 1 | 1 | 1 | 0 | 1 | 1 |
| 16 | 1 | 1 | 1 | 0 | 1 | 1 | 1 | 0 | 0 | 1 | 0 |
| 17 | 1 | 0 | 0 | 1 | 1 | 1 | 0 | 0 | 1 | 0 | 0 |
| 18 | 1 | 1 | 0 | 1 | 1 | 1 | 1 | 1 | 0 | 0 | 0 |
| 19 | 1 | 0 | 0 | 0 | 0 | 1 | 1 | 0 | 0 | 0 | 0 |
| 20 | 1 | 0 | 1 | 0 | 0 | 0 | 1 | 0 | 0 | 0 | 1 |
| 21 | 1 | 1 | 0 | 1 | 0 | 0 | 0 | 0 | 0 | 1 | 1 |
| 22 | 1 | 0 | 0 | 0 | 1 | 0 | 0 | 1 | 1 | 0 | 1 |
| 23 | 1 | 1 | 1 | 0 | 1 | 0 | 0 | 0 | 1 | 1 | 1 |
| 24 | 1 | 1 | 1 | 1 | 1 | 0 | 1 | 1 | 1 | 1 | 0 |
| 25 | 1 | 1 | 0 | 0 | 0 | 1 | 1 | 1 | 0 | 0 | 1 |
| 26 | 1 | 0 | 1 | 1 | 0 | 1 | 0 | 0 | 1 | 1 | 0 |
| 27 | 1 | 1 | 1 | 1 | 0 | 1 | 0 | 1 | 1 | 1 | 0 |
| 28 | 1 | 0 | 1 | 0 | 1 | 1 | 1 | 0 | 1 | 0 | 0 |
| 29 | 1 | 0 | 1 | 1 | 1 | 1 | 1 | 1 | 1 | 0 | 0 |
| 30 | 1 | 1 | 1 | 1 | 1 | 1 | 1 | 1 | 1 | 1 | 1 |
| 31 | 1 | 0 | 0 | 0 | 0 | 0 | 0 | 0 | 0 | 0 | 0 |

In some embodiments, if the payload size A≤11, CRC bits are not attached. The output bit sequence is denoted by where c₀, c₁, c₂, c₃, . . . , c_{K-1}, where cᵢ=aᵢ for i=0, 1, . . . , A−1 and K=A. If the payload size 3≤A≤10, and the PUCCH resource is configured DMRSlessEncoding, I_{seq}=1, otherwise, I_{seq}=0.

In some embodiments, if high layer parameter DMRSlessEncoding is not configured or I_{seq}=0, the sequence shall be multiplied with the amplitude scaling factor β_{PUCCH,s}, s∈{3,4}, in order to conform to the transmit power specified TS 38.213 and mapped in sequence starting with rₗ(0) to resource elements (k,l)_{p,μ} on antenna port p=2000 according to:

a_{k,l}^{(p,μ)}=β_{PUCCH,s}·rₗ(m).

m=0,1, . . . ,M_{sc}^{PUCCH,s}−1 (10)

where k is defined relative to subcarrier 0 of the lowest-numbered resource block assigned for PUCCH transmission, 1 is given by Table 8 for the case with and without intra-slot frequency hopping and with and without additional DM-RS and with shortened DM-RS as described in TS 38.213, where l=0 corresponds to the first OFDM symbol of the PUCCH transmission. In this way, the network device 120 may decode the first bit in the sequence based on the DMRS when performing maximum likelihood. The overhead of the DMRS can be reduced. The resource elements (k,l)_{p,μ} shall be within the resource blocks assigned for PUCCH transmission according to TS 38.213.

TABLE 8

| | DM-RS position l within PUCCH span | | | | | |
|---|---|---|---|---|---|---|
| | No additional | | Additional | | Shortened | |
| | DM-RS | | DM-RS | | DM-RS | |
| PUCCH | No | | No | | No | |
| length | hopping | Hopping | hopping | Hopping | hopping | Hopping |
| 4 | 1 | 0, 2 | 1 | 0, 2 | 1 | 0 |

| | | | |
|---|---|---|---|
| 5 | 0, 3 | 0, 3 | 0 |
| 6 | 1, 4 | 1, 4 | 1 |
| 7 | 1, 4 | 1, 4 | 1 |
| 8 | 1, 5 | 1, 5 | 1 |
| 9 | 1, 6 | 1, 6 | 1 |
| 10 | 2, 7 | 1, 3, 6, 8 | 2 |
| 11 | 2, 7 | 1, 3, 6, 9 | 2 |
| 12 | 2, 8 | 1, 4, 7, 10 | 2 |
| 13 | 2, 9 | 1, 4, 7, 11 | 2 |
| 14 | 3, 10 | 1, 5, 8, 12 | 3 |

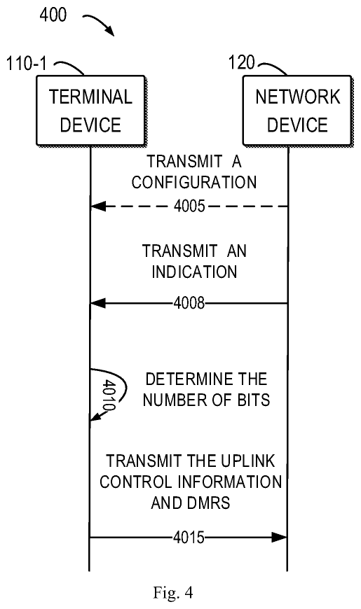

FIG. 4 shows a signaling chart illustrating process 400 among network devices according to some example embodiments of the present disclosure. Only for the purpose of discussion, the process 400 will be described with reference to FIG. 1. The process 400 may involve the terminal device 110-1 and the network device 120 in FIG. 1.

In some embodiments, the network device 120 may transmit 4005 a configuration to the terminal device 110-1. The configuration may indicate different number of demodulation reference signals configured for different sets of uplink resources. In some embodiments, shortened DMRS can be configured per PUCCH resource set since different UCI bit size may belong to different PUCCH resource set. Due to this configuration, shortened DMRS can be used only for small UCI bit size. In other embodiments, the configuration may be preconfigured at the terminal device 110-1. In this way, it improves performances of the transmission. Further, the overhead of the DMRS can be reduced by using the shortened DMRS.

The network device 120 may transmit 4008 an indication for a transmission of the uplink control information. For example, the indication may be transmitted via downlink control information (DCI). Alternatively, the indication may be transmitted via RRC signaling.

The terminal device 110-1 may determine 4010 the number of bits in the uplink control information based on a set of uplink resources for transmitting the uplink channel. If the number of bits is below a threshold number, the terminal device 110-1 may transmit 4015 a reduced number of DMRS and the sequence on the sequence on the uplink control information on the set of uplink resources.

In some embodiments, the sequence shall be multiplied with the amplitude scaling factor β_{PUCCH,2} in order to conform to the transmit power specified in TS 38.213 and mapped in sequence starting with r(0) to resource elements (k,l)_{p,μ} in a slot on antenna port p=2000 according to

$${a}_{k , l}^{( p , μ )} = {β}_{PUCCH , 2} {r}_{l} ( m ) \qquad ( 11 )$$

$$k = \{ \begin{matrix}3 m + 1 & no shortened DMRS \\ 6 m + 1 & shortened DMRS enabled\end{matrix}$$

where k is defined relative to subcarrier 0 of common resource block 0 and (k,l)_{p,μ} shall be within the resource blocks assigned for PUCCH transmission according to TS 38.213.

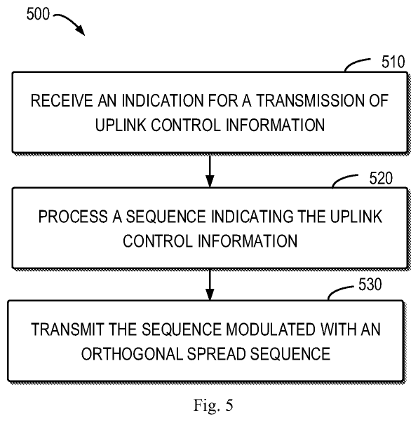

FIG. 5 shows a flowchart of an example method 500 in accordance with an embodiment of the present disclosure. Only for the purpose of illustrations, the method 500 can be implemented at a terminal device 110-1 as shown in FIG. 1.

In some embodiments, the terminal device 110-1 may receive a configuration from the network device 120. The configuration may be transmitted via a higher layer. For example, the configuration may be transmitted in radio resource control signaling. Alternatively, the configuration may be transmitted in downlink control information. The configuration may indicate a PUCCH format mode. For example, the configuration may comprise a parameter PUCCHformat1CovEnh. Only for the purpose of illustrations, the PUCCH format mode may be PUCCH format 1A. It should be noted that the PUCCH format mode may be any suitable mode. In some embodiments, the configuration may also indicate resources allocated to the terminal device 110-1 for UCI.

At block 510, the terminal device 110-1 receives an indication for a transmission of the uplink control information. For example, the indication may be transmitted via downlink control information (DCI). Alternatively, the indication may be transmitted via RRC signaling.

In some embodiments, the terminal device 110-1 may generate a value corresponding to information bits in UCI. In some embodiments, the value is a binary value. In other embodiments, the value may be any appropriate value. In some embodiments, the terminal device 110-1 may generate a sequence indicating the UCI based on the value.

At block 520, the terminal device 110-1 processes the sequence indicating the UCI with a cyclic shift based on the configuration. In some embodiments, the terminal device 110-1 may determine a sequence cyclic shift based on the uplink control information and the configuration. In this way, the sequence cyclic shift may carry the uplink control information. The terminal device 110-1 may determine the cyclic shift based on the sequence cyclic shift and an initial cyclic shift in the configuration.

In some embodiments, the terminal device 110-1 may modulate the sequence with an orthogonal spread sequence based on the configuration. For example, the sequence may be spread with the orthogonal sequence.

At block 530, the terminal device 110-1 transmits the sequence to the network device 120. For example, the sequence may be transmitted on the resources indicated in the configuration. In this way, transmission resources can be saved. Further, it reduces the burden of maximum likelihood detection.

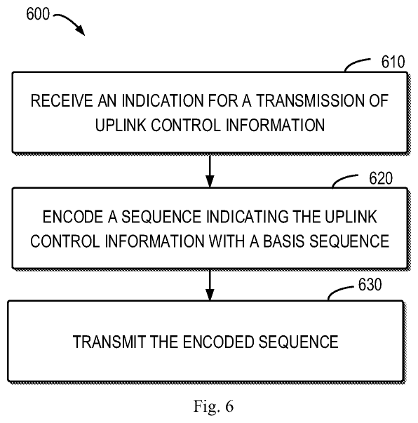

FIG. 6 shows a flowchart of an example method 600 in accordance with an embodiment of the present disclosure. Only for the purpose of illustrations, the method 600 can be implemented at a terminal device 110-1 as shown in FIG. 1.

In some embodiments, the terminal device 110-1 may receive a configuration from the network device 120. The configuration may indicate that on demodulation reference signal (DMRS) is transmitted. In some embodiments, the configuration may indicate that DMRS-less mode is used per enhanced PUCCH format. For example, the further configuration may comprise a parameter DMRSlessEncoding. The further configuration may be transmitted via higher layers.

At block 610, the terminal device 110-1 receives an indication for a transmission of the uplink control information. For example, the indication may be transmitted via downlink control information (DCI). Alternatively, the indication may be transmitted via RRC signaling.

At block 620, the terminal device 110-1 encodes the sequence with a basis sequence. The basis sequence may exclude at least one subset of basis sequence comprising consecutive same value of bits only. For example, the terminal device 110-1 may transmit the sequence to the network device 120. In this way, the complex of the modulated sequence is reduced. Since there is no DMRS used and the channel properties cannot be obtained, the first column in the basis sequence indicating whether the uplink control information is inverted may not be useful any more. For example, the first column in the basis sequence can indicate whether the uplink control information is inverted before transmission but the network device 120 cannot determine whether the uplink control information is inverted through the channel without the DRMS. Therefore, the bit indicating inverting the uplink control information can be omitted.

At block 630, the terminal device 110-1 transmits the sequence to the network device 120.

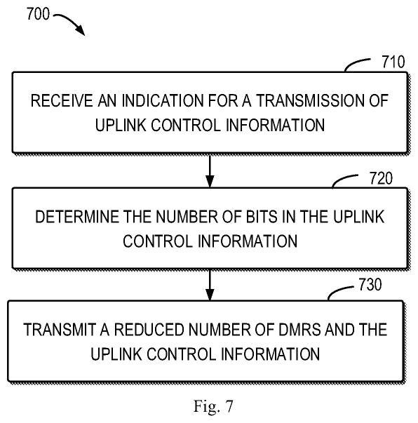

FIG. 7 shows a flowchart of an example method 700 in accordance with an embodiment of the present disclosure. Only for the purpose of illustrations, the method 700 can be implemented at a terminal device 110-1 as shown in FIG. 1.

In some embodiments, the terminal device 110-1 may receive a configuration from the network device 120. The configuration may indicate different number of demodulation reference signals configured for different sets of uplink resources. In some embodiments, shortened DMRS can be configured per PUCCH resource set since different UCI bit size may belong to different PUCCH resource set. Due to this configuration, shortened DMRS can be used only for small UCI bit size. In other embodiments, the configuration may be preconfigured at the terminal device 110-1. In this way, it improves performances of the transmission. Further, the overhead of the DMRS can be reduced by using the shortened DMRS.

At block 710, the terminal device 110-1 receives an indication for a transmission of the uplink control information. For example, the indication may be transmitted via downlink control information (DCI). Alternatively, the indication may be transmitted via RRC signaling.

At block 720, the terminal device 110-1 determines the number of bits in the uplink control information based on a set of uplink resources for transmitting the uplink channel. If the number of bits is below a threshold number, the terminal device 110-1 may transmit 4015 a reduced number of DMRS and the sequence on the sequence on the uplink control information on the set of uplink resources.

At block 730, the terminal device 110-1 transmits the sequence to the network device 120.

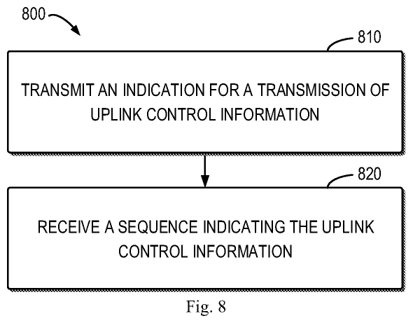

FIG. 8 shows a flowchart of an example method 800 in accordance with an embodiment of the present disclosure. Only for the purpose of illustrations, the method 800 can be implemented at a network device 120 as shown in FIG. 1.

In some embodiments, the network device 120 transmits a configuration for processing UCI to the terminal device 110-1. The configuration may be transmitted via a higher layer. For example, the configuration may be transmitted in radio resource control signaling. Alternatively, the configuration may be transmitted in downlink control information. The configuration may indicate a PUCCH format mode. For example, the configuration may comprise a parameter PUCCHformat1CovEnh. Only for the purpose of illustrations, the PUCCH format mode may be PUCCH format 1A. It should be noted that the PUCCH format mode may be any suitable mode. In some embodiments, the configuration may also indicate resources allocated to the terminal device 110-1 for UCI.

At block 810, the network device 120 transmits an indication for a transmission of the uplink control information. For example, the indication may be transmitted via downlink control information (DCI). Alternatively, the indication may be transmitted via RRC signaling.

At block 820, the network device 120 receives a sequence indicating the uplink control information from the terminal device. The sequence may be processed with a cyclic shift based on the configuration and modulated with an orthogonal spread sequence.

In some embodiments, the cyclic shift is determined based on a sequence cyclic shift and an initial cyclic shift indicated in the configuration, the sequence cyclic shift being determined based on the uplink control information and the configuration.

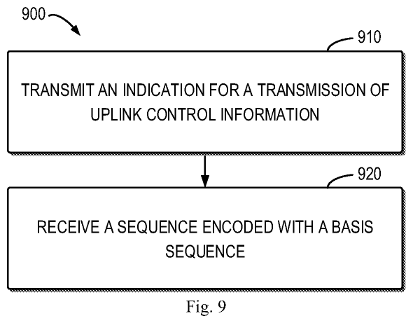

FIG. 9 shows a flowchart of an example method 900 in accordance with an embodiment of the present disclosure. Only for the purpose of illustrations, the method 900 can be implemented at a network device 120 as shown in FIG. 1.

In some embodiments, the network device 120 may transmit a configuration to the terminal device 110-1. The configuration may indicate that on demodulation reference signal (DMRS) is transmitted. In some embodiments, the configuration may indicate that DMRS-less mode is used per enhanced PUCCH format. For example, the configuration may comprise a parameter DMRSlessEncoding. The further configuration may be transmitted via higher layers.

At block 910, the network device 120 transmits an indication for a transmission of the uplink control information. For example, the indication may be transmitted via downlink control information (DCI). Alternatively, the indication may be transmitted via RRC signaling.

At block 920, the network device 120 receives a sequence encoded with a basis sequence which excludes at least one subset of basis sequence comprising consecutive same value of bits only.

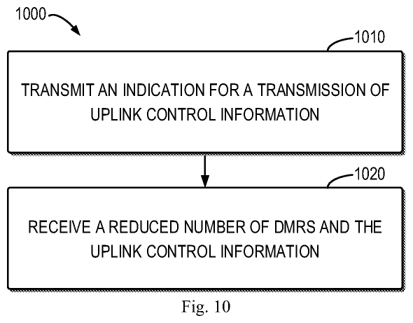

FIG. 10 shows a flowchart of an example method 1000 in accordance with an embodiment of the present disclosure. Only for the purpose of illustrations, the method 1000 can be implemented at a network device 120 as shown in FIG. 1.

In other embodiments, the network device 120 may transmit a configuration to the terminal device 110-1. The configuration may indicate different number of demodulation reference signals configured for different sets of uplink resources. In some embodiments, shortened DMRS can be configured per PUCCH resource set since different UCI bit size may belong to different PUCCH resource set. Due to this configuration, shortened DMRS can be used only for small UCI bit size. In this way, it improves performances of the transmission. If the number of bits is below a threshold number, the network device 120 may receive a reduced number of DMRS and the sequence on the sequence on the uplink control information on the set of uplink resources.

At block 1010, the network device 120 transmits an indication for a transmission of the uplink control information. For example, the indication may be transmitted via downlink control information (DCI). Alternatively, the indication may be transmitted via RRC signaling.

At block 1020, the network device 120 receives from the terminal device 110-1 a reduced number of demo if the number of bits in the uplink control information is below a threshold number. In this way, the network device 120 may decode the first bit in the sequence based on the DMRS when performing maximum likelihood. The overhead of the DMRS can be reduced.

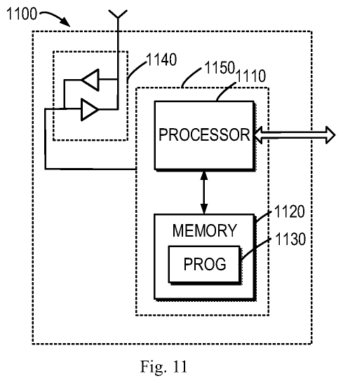

FIG. 11 is a simplified block diagram of a device 1100 that is suitable for implementing embodiments of the present disclosure. The device 1100 can be considered as a further example implementation of the network device 110 or the terminal device 120 as shown in FIG. 1. Accordingly, the device 1100 can be implemented at or as at least a part of the network device 110 or the terminal device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A communication method comprising:
receiving, at a terminal device and from a network device, an indication for a transmission of uplink control information; and
transmitting, to the network device, a sequence indicating the uplink control information, the sequence being processed with a cyclic shift and modulated with an orthogonal spread sequence.

24. The method of claim 23, wherein the cyclic shift is determined based on a sequence cyclic shift and an initial cyclic shift, the sequence cyclic shift being determined based on the uplink control information and a configuration.

25. The method of claim 23, wherein the orthogonal spread sequence is represented as:
$${w}_{i} ( m ) = {e}^{j 2 π \cdot i \cdot m / {N}_{SF , {m}^{′}}^{PUCCH , 1 A}} ,$$
wherein wᵢ(m) represents the orthogonal sequence, i represents an index of the orthogonal sequence to use, m represents the m^{th} symbol in the orthogonal sequence, and
N_{SF,m′}^{PUCCH,1A} represents length of physical uplink control channel (PUCCH) transmission in a slot.

26. The method of claim 23, wherein the sequence is modulated with the orthogonal spread sequence according to:
z(m′N_{sc}^{RB}N_{SF,0}^{PUCCH,1A}+mN_{sc}^{RB}+n)=wᵢ(m)·r_{u,v}^{(α,δ)}(n),
wherein wᵢ(m) represents the orthogonal sequence, i represents an index of the orthogonal sequence to use, m represents the m^{th} symbol in the orthogonal sequence, N_{SF,0}^{PUCCH,1A} represents length of PUCCH transmission in a subframe, r_{u,v}^{(α,δ)}(n) represents the processed sequence, α represents the cyclic shift, u represents a group number of a group of base sequences, v represents a base sequence number within the group of base sequences, n represents the n^{th} subcarriers in the resource block, the value of is δ configured by the network device, N_{sc}^{RB} represents the number of subcarriers in a resource block, m′ represents whether intra-slot frequency hopping is enabled and z represents the modulated sequence.

27. A communication method comprising:
receiving, at a terminal device and from a network device, an indication for a transmission of uplink control information;
encoding a sequence indicating the uplink control information with a basis sequence which excludes at least one subset of basis sequence comprising consecutive same value of bits only; and
transmitting the encoded sequence to the network device.

28. The method of claim 27, wherein the sequence is encoded by:
di=(Σₖ₌₀^{K-1}cₖ·M_{i,k+1})mod 2,
wherein K represents a payload size of the uplink control information, M_{i,k+1} represents the basis sequence, cₖ represents the sequence, k represents the k^{th} column in the basis sequence, i represents the i^{th} row in the basis sequence, and d represents the encoded bit in the uplink control information.

29. The method of claim 27, further comprising:
receiving, from the network device, a configuration indicating that no demodulation reference signal (DMRS) is transmitted.

30. A terminal device comprising:
a processor; and
a memory coupled to the processor and storing instructions thereon, the instructions, when executed by the processor, causing the terminal device to:
receive, from a network device, an indication for a transmission of uplink control information; and
transmit, to the network device, a sequence indicating the uplink control information, the sequence being processed with a cyclic shift and modulated with an orthogonal spread sequence.

31. The terminal device of claim 30, wherein the cyclic shift is determined based on a sequence cyclic shift and an initial cyclic shift, the sequence cyclic shift being determined based on the uplink control information and a configuration.

32. The terminal device of claim 30, wherein the orthogonal spread sequence is represented as:
$${w}_{i} ( m ) = {e}^{j 2 π \cdot φ ( m ) / {N}_{SF , {m}^{′}}^{PUCCH , 1 A}} ,$$
wherein wᵢ(m) represents the orthogonal sequence, i represents an index of the orthogonal sequence to use, m represents the m^{th} symbol in the orthogonal sequence, and
N_{SF,m′}^{PUCCH,1A} represents length of physical uplink control channel (PUCCH) transmission in a slot.

33. The terminal device of claim 30, wherein the sequence is modulated with the orthogonal spread sequence according to:
z(m′N_{sc}^{RB}N_{SF,0}^{PUCCH,1A}+mN_{sc}^{RB}+n)=wᵢ(m)·r_{u,v}^{(α,δ)}(n),
wherein wᵢ(m) represents the orthogonal sequence, i represents an index of the orthogonal sequence to use, m represents the m^{th} symbol in the orthogonal sequence, N_{SF,0}^{PUCCH,1A} represents length of PUCCH transmission in a subframe, r_{u,v}^{(α,δ)}(n) rep processed sequence, α represents the cyclic shift, u represents a group number of a group of base sequences, v represents a base sequence number within the group of base sequences, n represents the n^{th} subcarriers in the resource block, the value of is δ configured by the network device, N_{sc}^{RB} represents the number of subcarriers in a resource block, m′ represents whether intra-slot frequency hopping is enabled and z represents the modulated sequence.
